(19) United States
(12) Patent Application Publication
(10) Pub. No.: US 2002/0125430 A1
(43) Pub. Date: Sep. 12, 2002

(54) Bolometer operation using fast scanning

(75) Inventor: Roland A. Wood, Bloomington, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 09/800,366

(22) Filed: Mar. 6, 2001

(51) Int. Cl. G01J 5/00

(52) U.S. Cl. 250/338.1; 250/332

(57) ABSTRACT

A method and apparatus to apply two or more bias pulses sequentially to each of the microbolometers of an array during each frame time, then measuring the resulting signals associated with each of the two or more bias pulses, then computing an average signal value in each frame time for each microbolometer, resulting in more uniform microbolometer temperature and improved sensitivity to infrared radiation.

### FIELD OF THE INVENTION

This invention relates generally to a microbolometer focal plane array, and more particularly pertains to an improved method and apparatus for microbolometer array operation.

### BACKGROUND

Thermal infrared detectors are detectors, which operate by sensing the heating effect of the infrared radiation. Thermal detectors generally do not need to be cooled below room temperature, which gives them an important practical advantage. Thermal infrared detectors that operate at room temperature have been known for 200 years, but recently the availability of integrated circuit and micromachining technology has greatly increased interest in this field. It is now practical to manufacture an array containing many thousands of thermal infrared detectors, which operates well at room temperature.

A bolometer is a thermal radiation detector that operates by absorbing incident electromagnetic radiation (typically infrared radiation), converting the absorbed infrared energy into heat, then indicating the resulting temperature change in the detector by a change in its electrical resistance, which is a function of temperature. A microbolometer is a small bolometer, typically a few tens of microns in lateral size. Microbolometer infrared imaging systems are typically designed to be sensitive to long wave infrared, typically in a wavelength range of about 8-12 micrometers. A two-dimensional array of such microbolometers, typically 120×160, can detect variations in the amount of radiation emitted from objects within its field of view and can form two-dimensional images therefrom. Linear arrays of microbolometers may similarly be formed to form line images. In such arrays of microbolometers, it is necessary to measure the resistance of all of the individual microbolometers in the array without compromising the signal to noise ratio of the microbolometers. Because it is impractical to attach thousands of electrical wires to such an array to measure all the microbolometer electrical resistances in the array, microbolometer arrays are typically built on a monolithic silicon called a “read out integrated circuit” (ROIC) which is designed to measure all the individual microbolometer electrical resistances in the array in a short time, called the “frame time.” The term “frame time” refers to a time in which a microbolometer array produces each complete picture or image of an object being viewed. The frame time is typically around 1/30^{th} of a second, but it can be faster or slower than the typical time of 1/30^{th} of a second. In order to allow the microbolometer array to respond adequately to time-dependent changes in the detected infrared radiation, the thermal response time of each microbolometer is typically adjusted, to be about the same value as the frame time. As a result, there remains the problem of how to efficiently measure the resistance of many thousands of microbolometers in the array (an array can have more than 80,000 microbolometers) within the size, power, and component restrictions placed on the ROIC, with the best possible signal to noise ratio.

A typical method used by the ROIC to measure the electrical resistance of all the microbolometers in the array is to apply a “bias pulse” of electrical voltage (or current) to each microbolometer in the array, and to measure a resulting signal current (or voltage). It is more common to apply a voltage bias pulse to each microbolometer in the array and to measure a resulting current signal from each microbolometer in the array during each frame time. However, in large arrays, it is usual to apply such bias pulses to more than one microbolometer simultaneously, and to measure the resulting signal currents simultaneously.

In the prior art, one single bias pulse is applied to each microbolometer in the array in each frame time. Application of a single bias pulse in each frame time can result in a temperature increase in the microbolometer over and above the heating effect of the incident radiation. Since, by necessity, such bias pulses have to be much shorter in time than the frame time, the heating effect is very rapid. Thus, when one bias pulse is applied to each microbolometer in the array in each frame time, the temperature of the microbolometer initially rises rapidly for a short time equal to the bias pulse duration, and then falls for the reminder of the frame time. The variation in temperature during each frame time due to such bias pulses is typically many times greater than the thermal signals caused by the incident radiation. This adds to the difficulty in detecting the signals caused by the incident radiation.

The “noise equivalent power” (NEP) of a microbolometer may be defined as the infrared radiation power change incident on a microbolometer that induces a signal current change equal to the “root mean square” (rms) current noise. The “noise equivalent temperature difference” (NETD) is another term that is often used in quantifying the performance of a microbolometer array. The NETD may be defined as the temperature change in a black-body target that produces a signal current change in the microbolometer equal to the rms current noise. In summary, the performance of the microbolometer array is generally measured in terms of the magnitudes of the NEP or NETD of the microbolometers used in the array. Generally, lower values of NEP and NETD correspond to a higher sensitivity and improved performance of the microbolometer array.

A common method for obtaining higher sensitivity and improved performance in a microbolometer is to increase the magnitude of the bias pulse. However, higher bias pulse magnitudes produce correspondingly higher heating pulses and temperature variations in the microbolometer. There is a need in the art to design and operate ROICs such that they allow improved sensitivity and performance of the microbolometer arrays without increasing the microbolometer temperature variations caused by the application of bias pulses.

### SUMMARY OF THE INVENTION

The present invention provides a method and apparatus to apply two or more bias pulses substantially sequentially to each of the one or more microbolometers in an array in a frame time, such that the resulting temperature in each of the microbolometers is substantially uniform during a frame time, and measure two or more resulting signals associated with each of the applied two or more bias pulses during the frame time. Further, computing an average signal value from the measured two or more resulting signals for each of the microbolometers in the array during each frame time. Thereafter, producing an output signal based on the computed average signal value to improve performance, sensitivity, and facility of operation of the array.

Other aspects of the invention will be apparent on reading the following detailed description of the invention and viewing the drawings that form a part thereof.

### BRIEF DESCRIPTION OF THE DRAWINGS

FIG. 1 illustrates a microbolometer array in an imaging system.

FIG. 2 illustrates a typical ROIC circuit.

FIG. 3 illustrates a typical circuit including an integrator and an A/D converter used to convert an output signal to a digital signal value.

FIG. 4 illustrates a prior-art method of operating each of the microbolometers in the array and their temperature variation.

FIG. 5 illustrates one embodiment of operating each of the microbolometers in the array and its temperature variation according to the present invention.

FIG. 6 shows a graph of calculated NEP versus level of applied input bias current pulses when scanning the array shown in FIG. 1 using prior art technique.

FIG. 7 shows a graph of calculated NEP versus level of applied input bias current pulses when scanning the array shown in FIG. 1 according to the present invention.

FIG. 8 illustrates a method of increasing performance and sensitivity of a microbolometer focal plane array.

FIG. 9 illustrates major components of infrared radiation detector apparatus and their interconnections according to the present invention.

### DETAILED DESCRIPTION

This document describes a system and method to electronically scan a microbolometer array to reduce NEP and increase performance and sensitivity of the array.

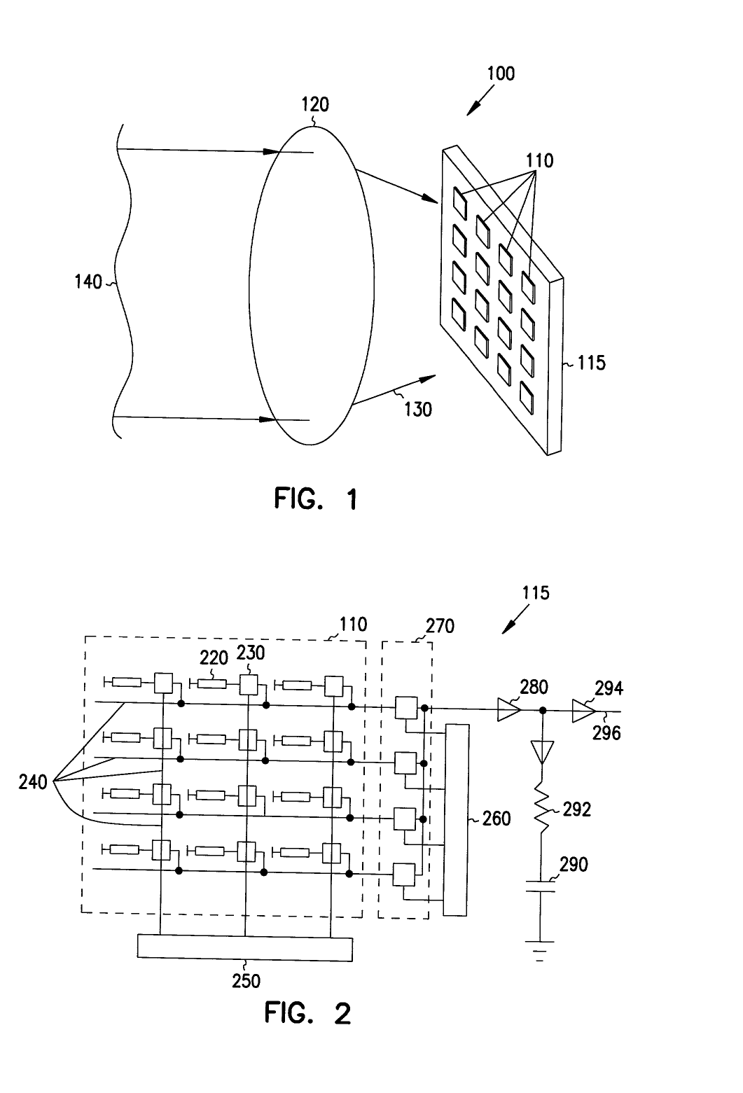

FIG. 1 illustrates one embodiment of microbolometer array 110 in an imaging system 100. The imaging system 100 further includes an infrared-transmitting lens 120. The array 110 can be a one or two-dimensional array. The array 110 is formed on a monolithic silicon called “read out integrated circuit” (ROIC) 115. In the embodiment shown in FIG. 1, the array 110 is disposed in the focal plane of the infrared-transmitting lens 120, such that the rays of infrared radiation 130 are focused onto the focal plane to produce an image of a distant object or scene 140, in a similar way that a photographic film produces an image when placed in the focal plane of a camera lens. The heating effect of the focused image causes temperature changes in individual microbolometers in the array 110. This temperature change in each of the microbolometers induces a change in resistance value in each of the microbolometers in the array 110. The ROIC 115 interrogates each microbolometer in the array 110 to measure the change in resistance in each of the microbolometers in the array 110. The change in resistance in each of the microbolometers in the array 110 is measured within a frame time. Generally, the frame time is approximately 1/30^{th} of a second. The thermal response time of each microbolometer in the array is generally tailored to be approximately equal to the frame time. The above-indicated measurement of the change in resistance in each of the microbolometers in the array 110 is repeated every frame time so that a realistic image of the scene and/or object 140 being viewed is displayed.

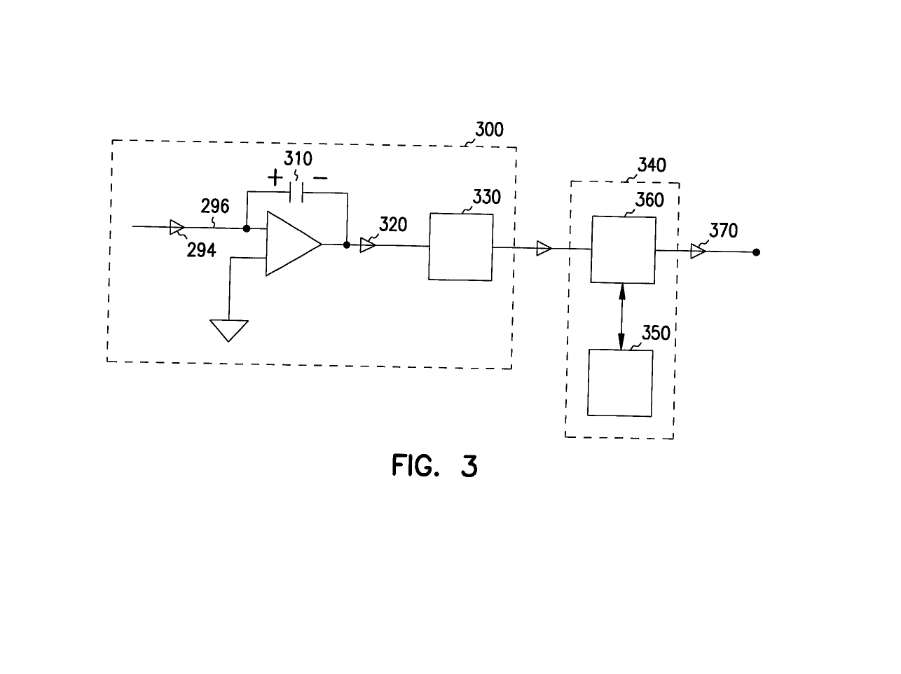

FIG. 2 illustrates one embodiment of a ROIC 115 used in forming the microbolometer array 110. Each microbolometer in the array 110 is represented as an electrical resistor 220. Associated with each microbolometer 220 in the array 110 is a field-effect transistor (FET) 230. The microbolometers 220 and the FETs 230 are interconnected by thin-film metallic conductors 240. The ROIC 115 further includes column and row shift registers 250 and 260. The column shift register 250 applies control voltages to columns of the array 110, and the shift register 260 applies control voltages to a row multiplexer 270. A global bias voltage is applied to all the microbolometers in the array 110. The output signal line 280 of the array 110 is held at zero volts by an external connection. In operation, the ROIC 115 applies control voltages so that only one microbolometer has an applied bias voltage (VDDR) across it, and a signal current flows along the corresponding thin-film metallic conductor 240, through the multiplexer 270, and out to the output signal line 280. Additional current is supplied from a voltage source 290 via a resistor 292 to substantially bring the net output current 294 close to zero. The voltage source 290 can apply different bias voltages (as noted in U.S. Pat. No. 4,752,694) to different microbolometers 220 in the array 110 during each time interval the microbolometers 220 are being biased, so that the output current remains close to zero even if the resistance of different microbolometers have slightly different resistance values, due to small fabrication variations between different microbolometers 220 in the array 110. This signal zeroing process is called “coarse non-uniformity correction,” and together with other methods and apparatus to correct for coarse non-uniformity, is taught in U.S. Pat. No. 4,752,694.

FIG. 3 illustrates a typical circuit 300 including integrator and an A/D converter connected to the output line 296 of ROIC 115 to convert the output current 294 to a digital signal value. The output current 294 from the output line 296 of the ROIC 115 is converted to a signal charge 310 and to a signal voltage 320. The signal voltage 320 goes through an analog-to-digital (A/D) converter 330.

Then the signal from the A/ID converter passes through a digital signal processor 340. The digital signal processor 340 comprises a digital memory 350, which holds correction values for each microbolometer in array 110, and a correction circuit 360. The correction circuit 360 corrects the final output using the correction values stored in the digital memory 350. The corrections are typically “fine offset corrections”, which removes small zero-error signals. The corrections can also include “gain correction,” which corrects for differing sensitivities between different microbolometers 220 in the array 110. The corrections can further include “dead pixel replacement,” which is a replacement of signal from poorly operating microbolometers in the array 110 with signal values derived from neighboring microbolometers.

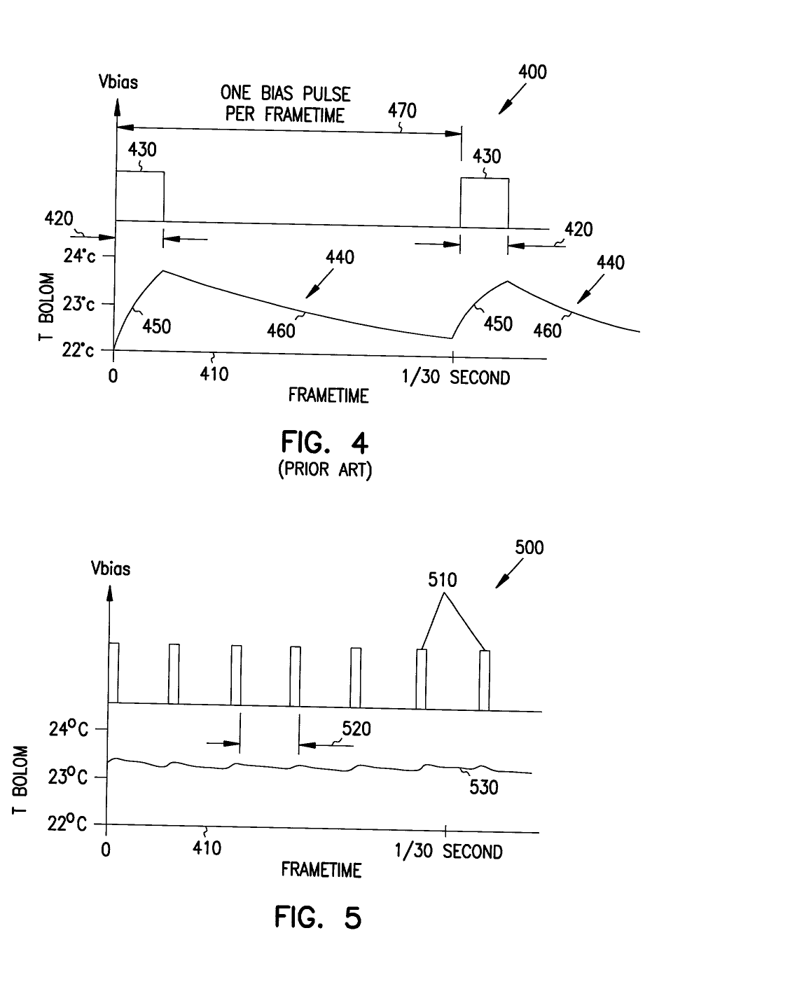

FIG. 4 is a graph 400 illustrating a prior-art method of operating each of the microbolometers 220 in the array 110. As illustrated in FIG. 4, the prior art method requires measuring microbolometer resistance values in the array 110 by dividing the frame time 410 into a number of time intervals 420 equal to the number of microbolometers 220 in the array 110, and applying a bias pulse to each of the microbolometers in the array within the computed equal time intervals 420. Thus, if the array 110 has an array size of ‘R×C’, and a frame time of ‘T’, then each bias pulse will have maximum time duration of (T/(R×C)). Therefore, each microbolometer in the array 110 is provided with one bias pulse 430 within the frame time 410. Alternatively, several microbolometers (N in number) in the array 110 could be simultaneously provided with one bias pulse in each frame time having a longer maximum time duration of ((T×N)/(R×C)).

Graph 400 also illustrates temperature variation 440 of each microbolometer caused by the application of the bias pulse 430. It can be seen from the graph 400 that the temperature variation 440 of each microbolometer in the array 110 is quite significant in each frame time 410. This is because the heating effect of each bias pulse 430 itself causes the temperature to rise rapidly in each microbolometer as shown in the graph 400. This temperature rise is over and above the heating effect of the incident infrared radiation 130. Since by necessity, as described above, the time duration of each bias pulse 430 is significantly shorter than the frame time 410, the heating effect of each bias pulse 430 is very rapid. Thus, when one bias pulse 430 is applied to each microbolometer in each frame time 410 as shown in FIG. 4, the temperature of each microbolometer in the array 110 initially rises rapidly 450, for a short time equal to the time duration 420 of the bias pulse 430. Then the temperature starts to fall 460 during the remainder of the frame time 410 as shown in FIG. 4. The variation of signal level caused by this temperature variation 440 is significantly greater than the signals generated by the incident infrared radiation 130.

FIG. 5 is a graph 500 illustrating one embodiment of operating each of the microbolometers in the array according to the teachings of the present invention. Instead of a single bias pulse 430 applied in the prior art as shown in FIG. 4, a series of two or more shorter-duration bias pulses 510 are applied substantially sequentially to each microbolometer in the array 110 within the frame time 410. The application of two or more bias pulses 510 to each of the microbolometers within the frame time 410 is referred to as “fast scanning.”

Again, assuming an array size of ‘R×C’, and a frame time of ‘T’, each microbolometer in the array 110 could receive ‘N’ fast scanning bias pulses 510 having a time duration not exceeding (T/(N×R×C)) within the frame time 410. Again, several microbolometers could be simultaneously provided with two or more longer bias pulses 510. Because fast scanning requires more frequent bias pulses, fast scanning is most easily applied to small two dimensional arrays and linear arrays.

Graph 500 also illustrates temperature variation in each microbolometer caused by the application of two or more bias pulses 510. It can be seen that the temperature variation of each microbolometer in the array 110 in each frame time 410 is significantly reduced by fast scanning. This is because the heating effect of shorter bias pulses is less. Also the shorter time duration 520 between the two or more bias pulses 510 allows less time for cooling to occur, also reducing the temperature variation to a lesser value 530 as shown in FIG. 5.

The fast scanning method 500 shown in FIG. 5 also improves array performance, relative to the prior art method of applying one bias pulse 430 to each microbolometer in the array in each frame time 410 shown in FIG. 4, as can be understood as follows: if the number of bias pulses N applied in each frame time to each microbolometer in the array 110, is greater than 1, and each is N times shorter in duration than the single bias pulse 430, then the noise bandwidth of the signals is increased to a higher frequency limit by a factor of N by fast scanning. Each signal therefore has N^{½} greater rms white noise, but there is no increase in low frequency noise, such as 1/f noise, since low frequency noise will generally fall substantially within the noise bandwidth for all values of N. If the N signal values from each microbolometer in each frame time are used to form an average signal value, the rms white noise is reduced to the N=1 value, and the low frequency noise rms value for noise frequencies approximately between the frame repetition rate frequency and the bias pulse repetition frequency is approximately reduced by the factor of N^{½} below the N=1 value. Thus, the final signal value that is obtained in each frame time can have a reduced amount of noise if N>1. Such reduced noise produces corresponding improvement factors in the array performance (reduced values of NEP and NETD).

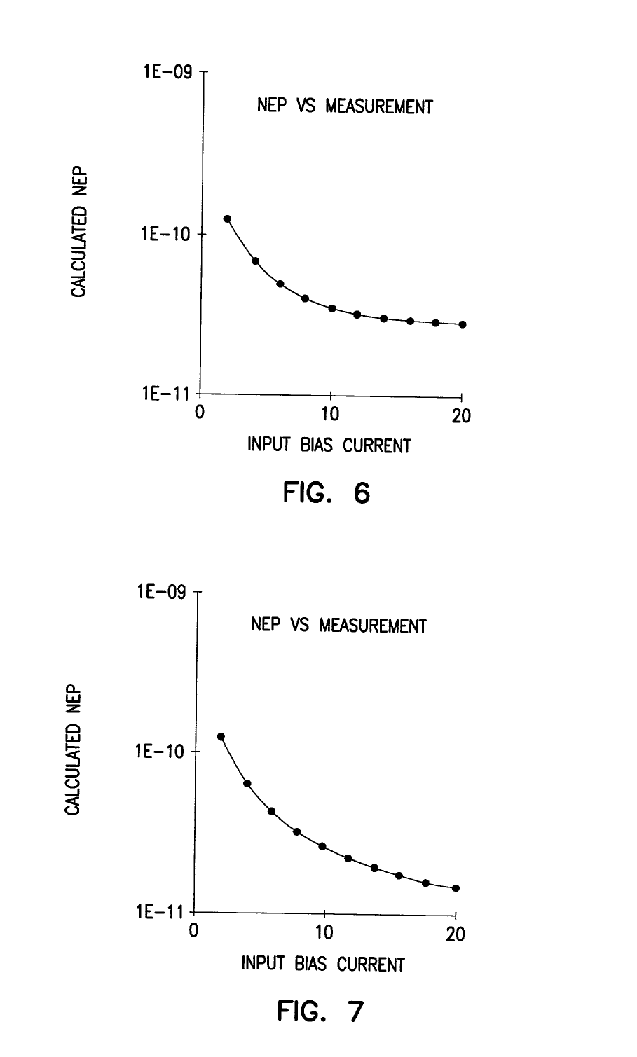

FIG. 6 shows a graph of calculated NEP versus level of applied input bias current pulses when scanning the array 110 shown in FIG. 1 using the prior art technique. FIG. 7 shows a graph of calculated NEP versus level of applied input bias current pulses when scanning the array 100 shown in FIG. 1 according to the present invention. All the parameters used in computing the NEP for the graphs shown in FIGS. 6 and 7 are kept constant during the scanning of the array 110 except for the different application of bias current pulses. It can be seen from the two graphs in FIGS. 6 and 7, that the calculated NEP in FIG. 7 is lower (with increasing input bias current) when compared with the calculated NEP in FIG. 6. This is due to the application of fast scanning bias current pulses according to the present invention, which results in a reduction in noise, which improves array performance.

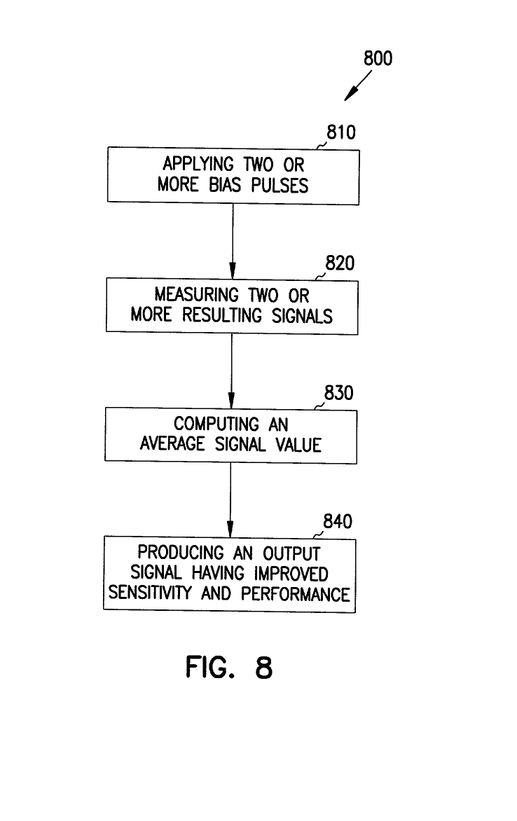

FIG. 8 illustrates an overview of one embodiment of the process 800 of the present invention. As illustrated in element 810, this process applies two or more bias pulses substantially sequentially to each of the microbolometers in an array in a frame time such that a resulting temperature in each of the microbolometers in the array due to the applying of the two or more bias pulses is substantially uniform during a frame time. The frame time is the time it takes for the array to produce one complete image of an object being viewed by the array. The two or more bias pulses can be substantially equal in magnitude. The two or more bias pulses can also be substantially equally spaced in time. The two or more bias pulses can be voltage bias pulses or bias current signals. The number of the two or more bias pulses can be in the range of about 2 to 100 bias pulses. They can have time duration in the range of about 0.1 to 20 microseconds.

Element 820 measures two or more resulting signals corresponding to the two or more bias pulses applied to each of the microbolometers in the array during the frame time. Element 830 computes an average signal value from the measured two or more resulting signals corresponding to each of the microbolometers in the array during the frame time. Element 840 produces an output signal based on the computed average signal value for each of the microbolometers in the array during the frame time to improve performance, sensitivity, and facility of operation of an array including one or more microbolometers. The above elements are repeated during each frame time to produce a realistic image of an object being viewed using the array. Further, the process 800 can include converting the uniform output signal value associated with each of the microbolometers of the array to a digital signal value using an integrator and an A/D converter. Further, the process 800 can also include passing the digital signal value associated with each of the microbolometers in the array through a digital image processor to correct for image defects such as fine offsets, gain non-uniformity, or dead pixels or any other such correcting operations to enhance the image quality. In some embodiments, the process 800 further includes applying a corrective electrical signal to the output signal to correct for resistance non-uniformity between the one or more microbolometers in the array to obtain a uniform output signal value. Also, the process 800 can include applying the corrective electrical signal to the output signal to correct for fine offsets, gain non-uniformity, and/or dead pixels.

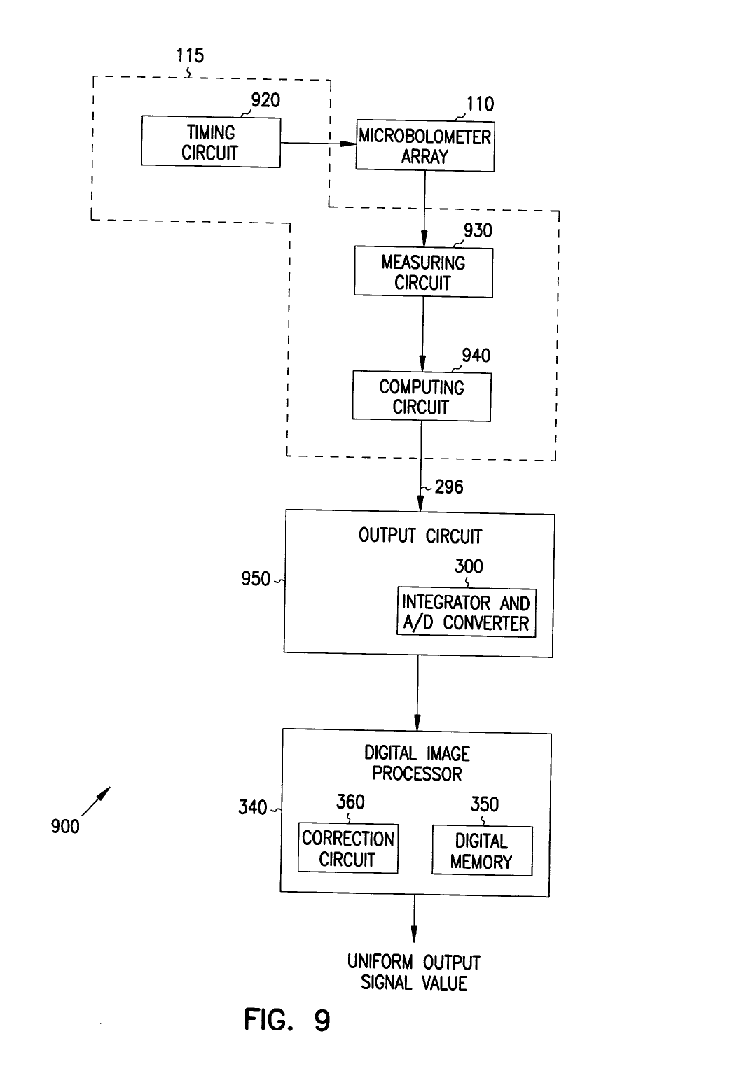

FIG. 9 illustrates major portions of an infrared radiation detector apparatus 900 and their interconnections according to the present invention. The infrared radiation detector apparatus 900 includes the microbolometer array 110, ROIC 115, a measuring circuit 950, and digital image processor 340.

The ROIC 115 includes a timing circuit 920 coupled to the microbolometer array 110 such that the timing circuit 920 can apply two or more bias pulses substantially sequentially to each of the microbolometers in the array 110 such that the resulting temperature in each of the microbolometers in the array 110 due to the application of the two or more bias pulses 510 is substantially uniform during a frame time 410. The frame time 410 is the time it takes for the microbolometer array 110 to produce a complete image of an object being viewed by the microbolometer array 110. The operation of the microbolometer array 110 has been described in detail with reference to FIGS. 1 and 2.

In some embodiments, the two or more bias pulses 510 applied to each microbolometer in each frame time are substantially equal in magnitude. The two or more bias pulses 510 can be substantially equally spaced in time within the frame time 410. The two or more bias pulses 510 can be voltage bias pulses. The two or more corresponding signals can be current signals. The number of the two or more bias pulses 510 can be approximately in the range of about 2 to 100 bias pulses. The two or more bias pulses 510 can have a time duration of approximately in the range of about 0.1 to 20 microseconds.

The signal circuit 930 is coupled to the microbolometer array 110 such that the two or more resulting signals associated with each of the two or more bias pulses 510 applied during the frame time 410 may be individually controlled. In some embodiments the signal circuit can apply corrective signals to produce coarse non-uniformity correction.

In some embodiments, the measuring circuit includes an integrator and an A/D converter 300. The integrator and the A/D converter 300 receive the output signal value associated with each microbolometer in the array 110 and converts the signal value to a digital signal value. The operation of the integrator and the A/D converter 300 has been discussed in detail with reference to FIG. 3.

In some embodiments, the infrared radiation detector apparatus 900 further includes a digital image processor 340. The digital image processor 340 is coupled to the measuring circuit 950 to receive the digital signal values associated with each of the microbolometers in the array 110 and computes an average signal value for each of the two or more resulting signals from the measuring circuit 930, producing an output signal based on the computed average signal value associated with each of the microbolometers in the array 110 such that the output signal improves performance, sensitivity, and facility of operation of the microbolometer array. The digital image processor can also correct the received digital signal value for image defects such as fine offsets, gain non-uniformity, or dead pixels, and can further correct for any resistance non-uniformity in each microbolometer in the array (to obtain a uniform output signal value) using a correction circuit 360 to improve the image quality. The digital image processor 340 can further include digital memories 350 to store the correction values associated with each of the microbolometers in the array 110.

### CONCLUSION

The above-described method and apparatus provides, among other things, improved microbolometer array performance and sensitivity, as indicated, by reduced NEP and NETD. Also, the above method and apparatus produces a reduced microbolometer temperature variation in each of the microbolometers in the array.

The above description is intended to be illustrative, and not restrictive. Many other embodiments will be apparent to those skilled in the art. The scope of the invention should therefore be determined by the appended claims, along with the full scope of equivalents to which such claims are entitled.

What is claimed is:

1. A method for improving performance and facility of operation of an array including one or more microbolometers, comprising:
applying two or more bias pulses substantially sequentially during a frame time to each of the microbolometers in the array;
measuring the two or more resulting signals corresponding to the bias pulses;
computing an average signal value from the resulting signals corresponding to each of the microbolometers in the array during the frame time; and
producing an output signal based on the computed average signal value for each of the microbolometers in the array during the frame time.

2. The method of claim 1, further comprising:
repeating the applying, measuring, computing, and producing steps to produce output signals during each frame time.

3. The method of claim 2, further comprising:
applying a corrective electrical signal to the microbolometer signals to correct for resistance non-uniformity between the one or more microbolometers in the array to obtain substantially uniform signal values.

4. The method of claim 3, further comprising:
converting the signal values associated with each of the microbolometers in the array to digital signal values.

5. The method of claim 4, further comprising:
passing the digital signal values associated with each of the microbolometers in the array to a digital image processor to perform computations and substantially remove image defects.

6. The method of claim 5, wherein the image defects comprises:
fine offsets, gain non-uniformity, dead pixels.

7. The method of claim 1, wherein the bias pulses are substantially equal in magnitude.

8. The method of claim 1, wherein the bias pulses are substantially equally spaced in time.

9. The method of claim 1; wherein the two or more applied electrical bias pulses comprise voltage bias pulses.

10. The method of claim 1, wherein the resulting electrical signals comprise current signals.

11. The method of claim 1, wherein the bias pulses are in the range of about 2 to 100 bias pulses.

12. The method of claim 1, wherein each of the two or more bias pulses has a time duration in the range of about 0.1 to 20 microseconds.

13. The method of claim 1, wherein the frame time is the time it takes for the array to produce a complete image of an object being viewed by the array.

14. An infrared radiation detector apparatus, comprising:
microbolometers in an array;
a timing circuit coupled to the array to apply two or more bias pulses substantially sequentially to each of the microbolometers in the array in each frame time;
a measuring circuit coupled to the array to measure two or more resulting signals associated with each of the applied two or more bias pulses during the frame time;
a computing circuit coupled to the measuring circuit to compute an average signal value for each of the microbolometers in the array from the measured two or more resulting signals during the frame time.

15. The apparatus of claim 14, wherein the measuring circuit further comprises an integrator and an A/D converter to convert the output signal values to a digital signal values.

16. The apparatus of claim 14, wherein the measuring circuit further comprises:
a correction circuit to apply a corrective electrical signal to the signals to correct for resistance non-uniformity between the microbolometers of the array to obtain a substantially uniform output signal value.

17. The apparatus of claim 14, wherein the computing circuit further comprises:
computing means to produce output signals based on the computed average signal value for each of the microbolometers in the array during the frame time.

18. The apparatus of claim 17, wherein the computing circuit further corrects the output signal values for fine offsets, gain non-uniformity, and dead pixels.

19. The apparatus of claim 18, wherein the computing circuit further comprises:
digital memories to store correction values for each of the microbolometers in the array.

20. The apparatus of claim 14, wherein the two or more bias pulses are substantially equal in magnitude.

21. The apparatus of claim 20, wherein the two or more pulses are substantially equally spaced in time.

22. The apparatus of claim 14, wherein the two or more bias pulses are voltage bias pulses.

23. The apparatus of claim 22, wherein the resulting signals are current signals.

24. The apparatus of claim 14; wherein the two or more bias pulses are in the range of about 2 to 100 bias pulses.

25. The apparatus of claim 24, wherein the two or more bias pulses have time duration in the range of about 0.1 to 20 microseconds.

26. The apparatus of claim 14, wherein the frame time is the time it takes for the array to produce a complete image of an object being viewed by the array.
